(19) United States
(12) Patent Application Publication
(10) Pub. No.: US 2018/0284999 A1
(43) Pub. Date: Oct. 4, 2018

(54) Data Migration with Application-Native Export and Import Capabilities

(71) Applicant: International Business Machines Corporation, Armonk, NY (US)

(72) Inventors: Muhammad S. Aslam, Ajax (CA); Ann M. Corrao, Raleigh, NC (US); Tiia J. Salo, Cary, NC (US); Ahron B. Train, Toronto (CA)

(21) Appl. No.: 15/471,137

(22) Filed: Mar. 28, 2017

(51) Int. Cl. G06F 3/06; G06F 17/30

(52) U.S. Cl. CPC G06F 3/0619; G06F 3/0688; G06F 17/30283; G06F 17/303; G06F 3/067; G06F 3/0647

(57) ABSTRACT

An approach is disclosed that identifies a migration condition at a data migration appliance that is migrating an application data set from a source data center to a target data center. The data migration appliance includes a set of processors, a memory, a nonvolatile storage device, and one or more external interfaces. The approach loads software application utilities that correspond to the application data set onto the data migration appliance. The approach then exports the application data set from the source data center to the nonvolatile storage device in the data migration appliance using one of the software application utilities. After transport of the appliance, the approach imports the application data set stored on the nonvolatile storage device to the target data center using one of the software application utilities.

### BACKGROUND

Application migration appliances are used to accelerate the transfer of large amounts of data between data centers or other large computer systems, bypassing traditional computer networks, such as the Internet. Traditional computer networks are bypassed due to the networks being too slow to transfer such large amounts of data. The large set of data is exported from the source computer system, such as a source data center, to nonvolatile storage included in the migration appliance. The migration appliance is then physically transported to the location of the target computer system, such as a target data center, where the data is imported from the migration appliance to the target computer system.

Traditional migration appliances are generic transfer devices that transfer block volumes or files and/or file systems in an application-agnostic fashion. A challenge of traditional migration appliances is that the end users or facilitators of the migration have to manage the exporting and importing of the data from and to the business applications and databases, and also perform any needed transformations and formatting of the data. These traditional approaches therefore require more skilled workers to manually perform various import and export functions and, consequently, take additional time to transfer the data to the target computer system in what is often a time-critical environment. A data migration typically involves an application data set. As the term is used in this document, an “application data set” is a set of data utilized by an application program. For example, in a database management system (DBMS), an application data set can be a relational table, hierarchical table, or other type of table depending on the type of DBMS that is being used.

### SUMMARY

An approach is disclosed that identifies a migration condition at a data migration appliance that is migrating an application data set from a source data center to a target data center. The data migration appliance includes a set of processors, a memory, a nonvolatile storage device, and one or more external interfaces. The approach loads software application utilities that correspond to the application data set onto the data migration appliance. The approach then exports the application data set from the source data center to the nonvolatile storage device in the data migration appliance using one of the software application utilities. After transport of the appliance, the approach imports the application data set stored on the nonvolatile storage device to the target data center using one of the software application utilities.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages will become apparent in the non-limiting detailed description set forth below.

### BRIEF DESCRIPTION OF THE DRAWINGS

This disclosure may be better understood by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a component diagram depicting transfer of a large set of application data from a source data center to a target data center using a migration appliance that includes application-native export and import capabilities;

FIG. 4 is a flowchart depicting steps performed to prepare a migration appliance to includes application-native export and import capabilities;

FIG. 5 is a flowchart depicting steps taken when exporting application data from a source data center using a migration appliance that includes application-native export and import capabilities; and

FIG. 6 is a flowchart depicting steps taken when importing application data to a target data center using a migration appliance that includes application-native export and import capabilities.

### DETAILED DESCRIPTION

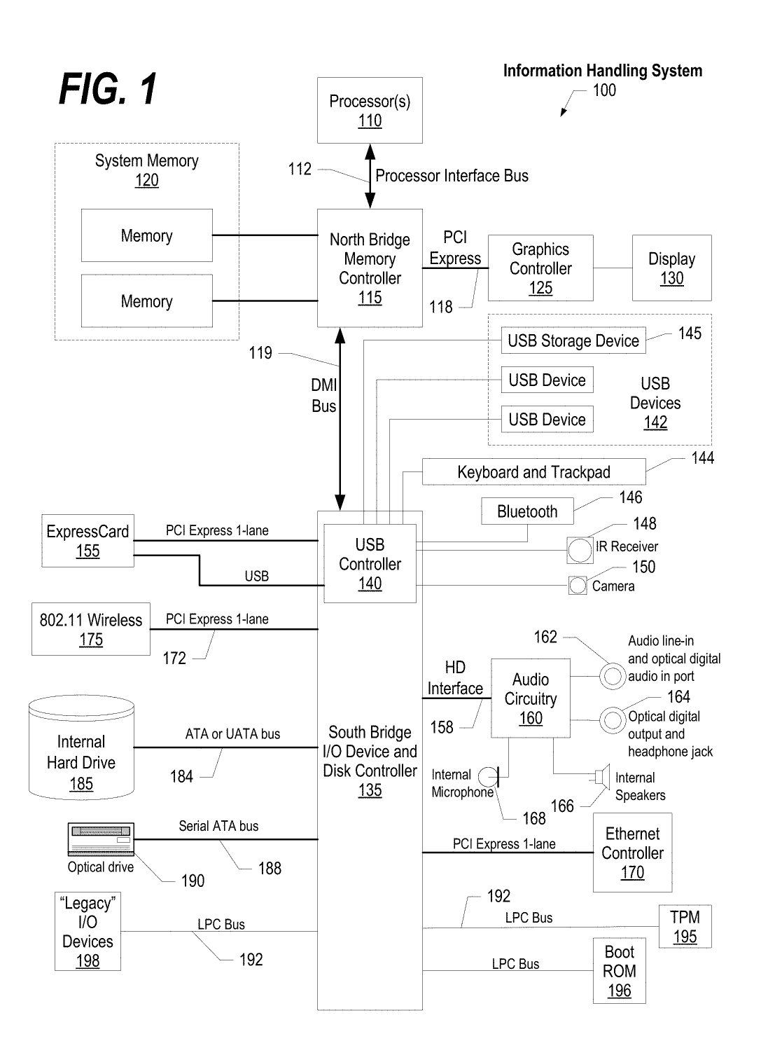

FIGS. 1-6 show an approach that extends the data migration appliance with application-native capability. As the term is used herein, “application-native capability” means a capability of reading and writing an application data set using an application program that is a “database management system (DBMS).” As the term is used herein: a DBMS provides at least the following types of functionality with respect to data of a database: (i) retrieving records from tables in the database, (ii) indexing records found in the database, (iii) retrieval of data using a structured query language (SQL), (iv) data definition that includes creation, modification and removal of definitions that define the organization of the data, (v) update of data including insertion, modification, and deletion of the actual data found in the database, (vi) retrieval that includes providing information in a form directly usable or for further processing by other applications. The retrieved data may be made available in a form basically the same as it is stored in the database or in a new form obtained by altering or combining existing data from the database, and (vii) administration of the database that includes registering and monitoring users, enforcing data security, monitoring performance, maintaining data integrity, dealing with concurrency control, and recovering information that has been corrupted by some event such as an unexpected system failure.

Conventional data migration appliances do not include application-native capabilities because they do not include DBMSs. Conventional data migration appliances typically do not perform any of the functions listed in the above definition of a DBMS. Further, conventional data migration appliances typically do not include the computing resources that would be needed to run a DBMS. These resources, lacking or in sufficient amount in conventional data migration appliances, include the following types of resources: installed DBMS systems installed on the data migration appliance and stand-alone utilities used to provide the functions listed in the previously provided definition of a DBMS.

The approach allows cloud migration customers to directly export and import data to and from the migration appliance using source and target application specific utilities, such as a data warehouse service's remote client. The approach provides a more simplified selection of different transfer mechanisms for complex migration jobs that may involve migration from/to multiple applications. The approach provides a plug-in architecture that allows many types of migrations to be integrated into the migration appliance rather than having separate application-specific migration mechanisms deployed. Consequently, the approach results in reduced on site equipment and resource requirements by minimizing deployment of additional intermediate servers hosting application-specific import/export utilities. Traditional approaches often require execution of migration-specific utilities on production systems that serve as the source or target data center. Often customers either do not want to run migration-specific code on production systems, or they may not be able to deploy code into a closed appliance. Without the application-native extension mechanism, customers would have to provide additional resources and systems for migration code that are external to either the data migration appliance or data source.

As used herein, a “migration appliance” is a hardware appliance used for migrating data. A source/destination application is an application used by a customer which provides data and services; which is to be transferred from a source computer system to a target computer system. A migration-specific utility and/or application is a utility that imports and/or exports data from the source and/or destination application (i.e., exports data from the source computer system to the migration appliance and/or imports data from the migration appliance to the target computer system). An extension is a migration-specific application encapsulated in a format that is specific for the migration appliance.

An embodiment is provided for incorporating the application-native migration capabilities is to provide the appliance with a plug-in based extension mechanism. Following this embodiment, the extensions are installed into a base image, with the description of the command line arguments and mapping of ports that the extension needs. Once the image is compiled, it can be deployed by the engine as an appliance extension. An alternate embodiment would have the extensions implemented as a virtual machine, or as part of the appliance stack.

The approach provides application-native migration features that have the following attributes. The approach presents features to the end user in a list for user selection. By making selections, the user can launch and stop migration utilities that import and export data. The user also has access to the local disk included on the migration appliance, and further has access to a computer network, such as the Internet, over the network adapter included in the migration appliance. A user interface (UI) is provided to list currently running features to allow the end user to pausing or stop a feature from the UI. In one embodiment, the approach provides resource mapping and management by the migration appliance. This resource mapping and management can include mapping/management of storage, network, or the CPU), and can be used to limit and/or control utilization of both the migration appliance's capabilities, and/or the application being accessed.

In another embodiment, separate migration-specific utilities can access the same set of data; such that data can be transferred from one type of application on import to a different type of application on export.

In one embodiment, the migration appliance is provisioned with such application-native export/import utilities that are required for a specific migration job, such as when a customer orders a migration appliance with a particular migration in mind.

In one embodiment, the application-native export/import utilities are stored on the migration appliance in a nonvolatile storage and cannot be altered by the customer.

In one embodiment, the migration appliance allows multiple extensions to be run in parallel, to provide the ability to transfer data from a number of different applications to a single migration appliance simultaneously.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. As used herein, a computer readable storage medium does not include a computer readable signal medium.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

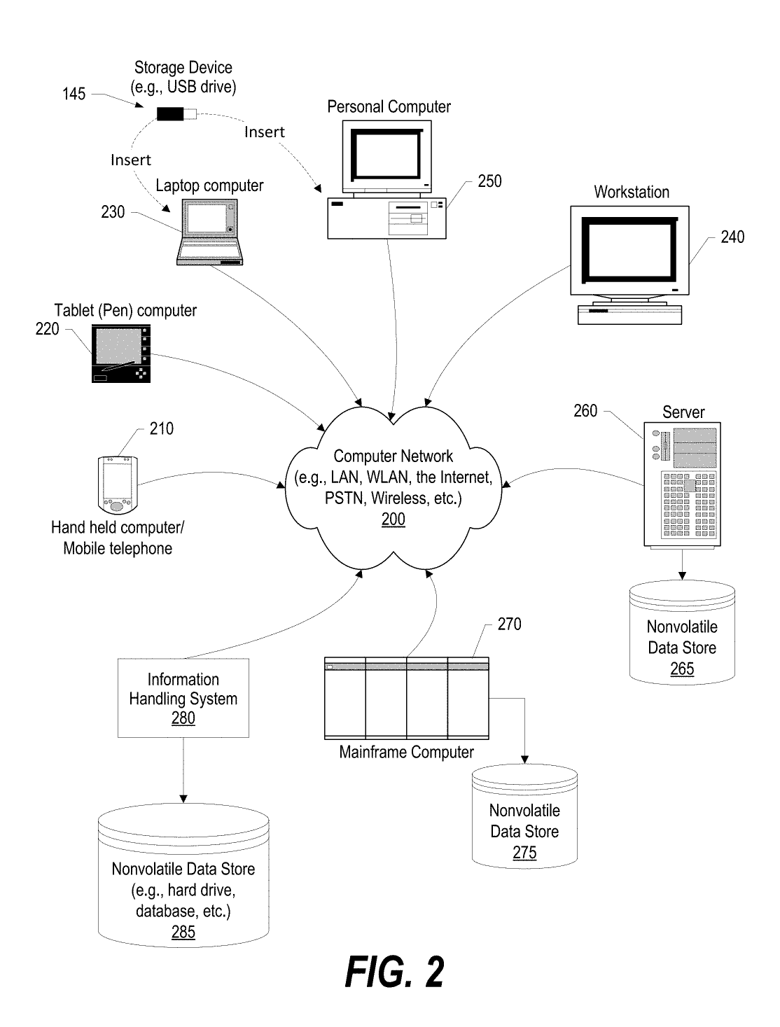

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

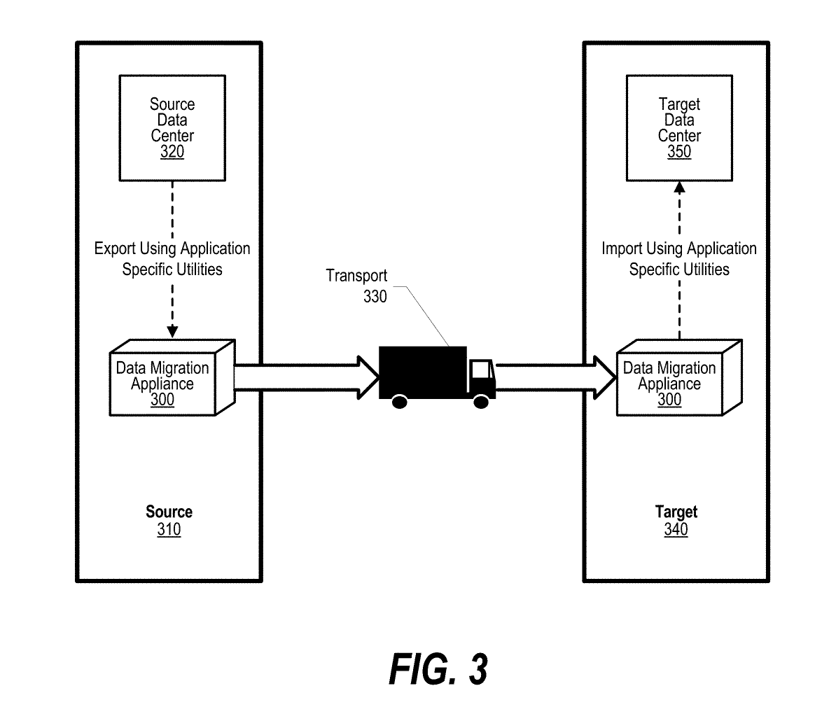

FIG. 3 is a component diagram depicting transfer of a large set of application data from a source data center to a target data center using a migration appliance that includes application-native export and import capabilities. Data migration appliance 300 is first used at source location 310 that is the location of source data center 320. Application data stored in source data center 320 is loaded onto data migration appliance 300. The data migration appliance is physically connected to source data center 320 using one or more physical interfaces, such as cables (e.g., universal serial bus, etc.) to export the application data set from source data center 320 to data migration appliance 300 using one or more software application utilities. If the customer is also migrating to a different application platform, such as to a different database management system (DBMS), export utilities installed on data migration appliance 300 might be used to load the application data set onto a nonvolatile storage device and also format the data stored in the data migration appliance from the first (source) DBMS format that was used at the source data center to a format used by the second (target) DBMS that is planned on being used at target data center 350.

After the application data set is exported from source data center 320 to data migration appliance 300, the data migration appliance is physically transported from source location 310 to target location 340 via one or more transportation mechanisms 330 such as ground transportation, air transportation, air transportation, and other transport mechanisms.

When it arrives at target location 340, data migration appliance 300 is physically connected to target data center 340 using one or more physical interfaces, such as cables (e.g., universal serial bus, etc.). Data that is being migrated that now resides on data migration appliance 300 is imported to target data center 350 using one or more software application utilities. If the customer is also migrating to a different application platform, such as to a different DBMS, import utilities installed on data migration appliance 300 might be used to load the application data set onto target data center 350 and also format the data stored in the data migration appliance from the first (source) DBMS format that was used at the source data center to a format used by the second (target) DBMS that is planned on being used at target data center 350.

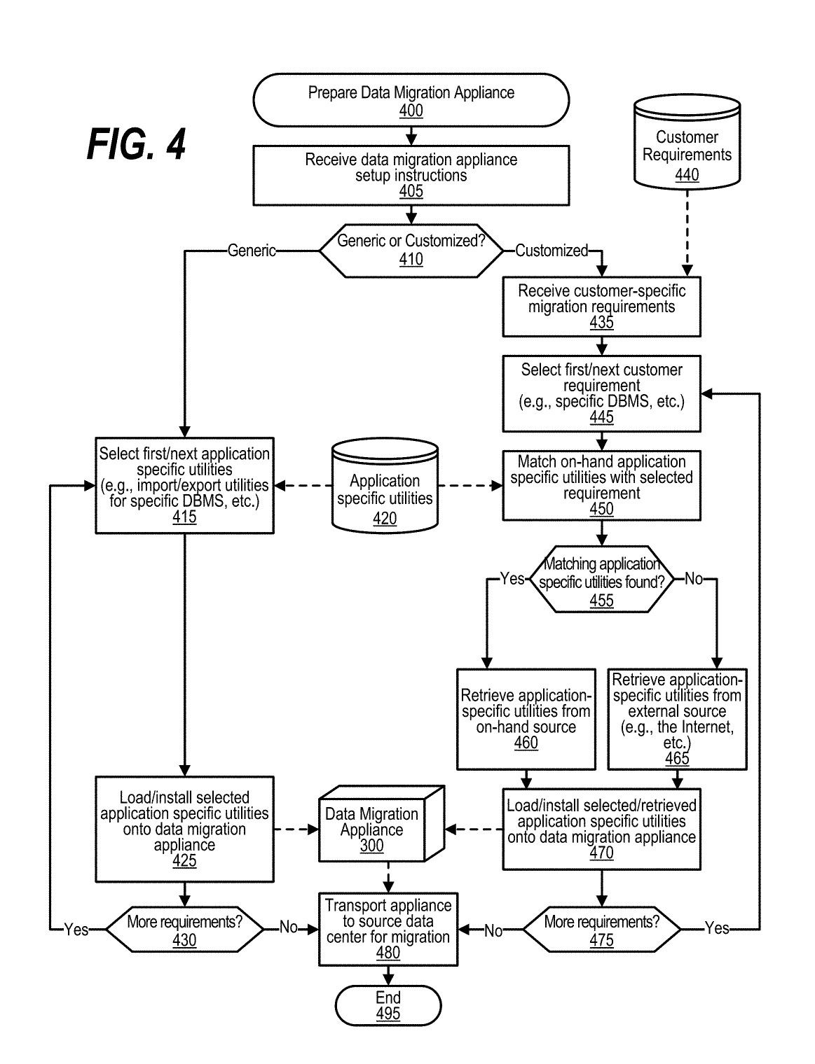

FIG. 4 is a flowchart depicting steps performed to prepare a migration appliance to includes application-native export and import capabilities. FIG. 4 processing commences at 400 and shows the steps taken by a process that prepares the Data Migration Appliance to migrate a customer's application data from a source data center to a target data center. At step 405, the process receives the data migration appliance setup instructions. These instructions include a migration condition, or requirement, such as different types of database management systems (DBMSs) used at the source data center and/or the target data center. The process determines as to whether the migration condition involves a generic or a customized software application utility (decision 410). A generic utility is one that corresponds to a well known or pseudo-standard application, such as a well known DBMS, while a customized utility might correspond to a lesser known, new, or experimental application, such as a brand new type of DBMS. If the setup instructions are generic instructions, then decision 410 branches to the ‘generic’ branch to perform steps 415 and 425. On the other hand, if the setup instructions are customized instructions, then decision 410 branches to the ‘customized’ branch to perform steps 435 through 470.

Taking the ‘generic’ branch, at step 415, the process selects the first application specific utilities (e.g., import/export utilities for specific DBMS, etc.) corresponding to the customer requirements stored in data store 440. At step 425, the process load and installs the selected application specific utilities onto data migration appliance 300. The process determines whether there are more customer requirements to process (decision 430). If there are more customer requirements to process, then decision 430 branches to the ‘yes’ branch which loops back to step 415 to select and then load/install the next application specific utility corresponding to the customer's requirements. This looping continues until there are no more customer requirements to process, at which point decision 430 branches to the ‘no’ branch exiting the loop.

When customized instructions are being processed, then steps 435 through 470 are performed. At step 435, the process receives customer-specific migration requirements from data store 440. At step 445, the process selects the first customer requirement, such as a specific DBMS that might be a new DBMS, experimental DBMS, or a lesser known DBMS. At step 450, the process matches the on-hand application specific utilities from data store 420 with the selected customer requirement. The process then determines whether the application specific utilities were found in data store 420 (decision 455). If the application specific utilities were found, then decision 455 branches to the ‘yes’ branch whereupon, at step 460, the process retrieves the application-specific utilities from an on-hand source (data store 420). On the other hand, if the application specific utilities were not found, then decision 455 branches to the ‘no’ branch whereupon, at step 465, the process retrieves the application-specific utilities from external source (e.g., the Internet, a DBMS provider's website, etc.). At step 470, the process load and installs the selected and retrieved application specific utilities onto data migration appliance 300.

The process determines whether there are more customer requirements to process (decision 475). If there are more customer requirements to process, then decision 475 branches to the ‘yes’ branch which loops back to step 445 to select and then loads and installs the next application specific utility corresponding to the customer's requirements. This looping continues until there are no more customer requirements to process, at which point decision 475 branches to the ‘no’ branch exiting the loop.

At step 480, the entity that prepared the data migration appliance transports the appliance to the source data center to commence migration of the customer's application data set. FIG. 4 processing thereafter ends at 495.

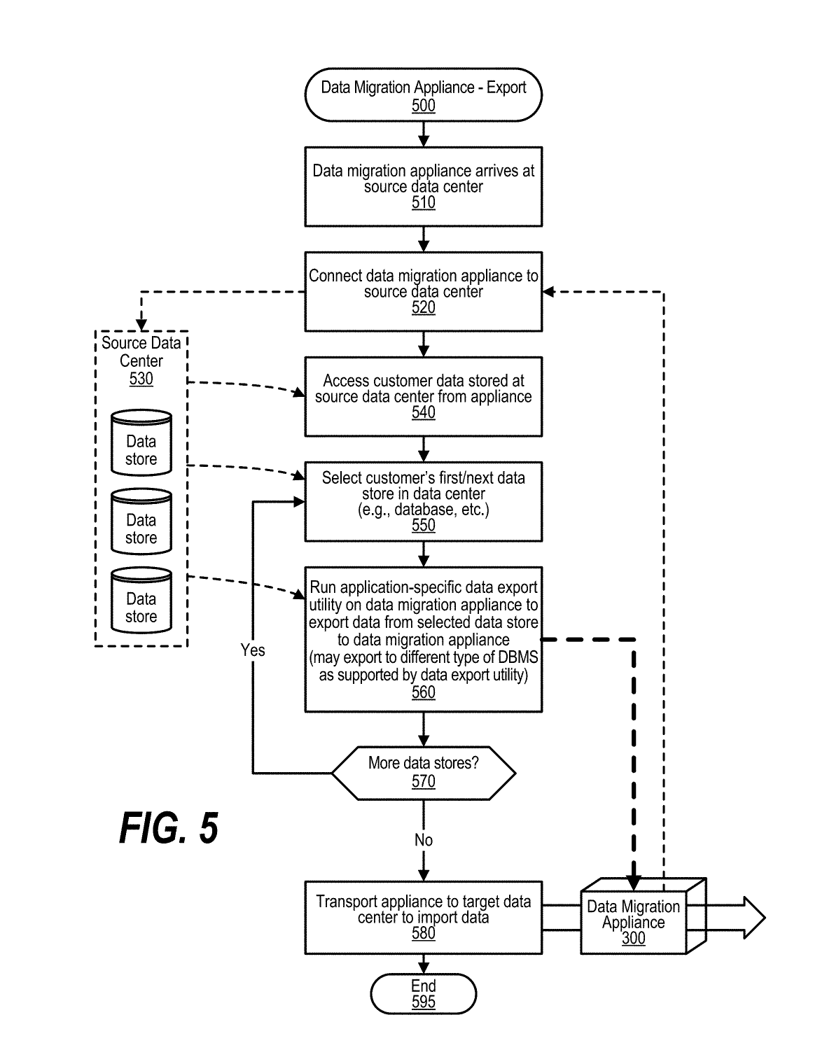

FIG. 5 is a flowchart depicting steps taken when exporting application data from a source data center using a migration appliance that includes application-native export and import capabilities. FIG. 5 processing commences at 500 and shows the steps taken by a process that performs data migration export operations at the source data center using the Data Migration Appliance. At step 510, the data migration appliance arrives at source data center. At step 520, the process connects the data migration appliance to source data center using an interface (e.g., USB interface(s), etc.).

At step 540, the process accesses the customer application data set that is being stored at source data center 530 with the access being from the data migration appliance. At step 550, the process selects the customer's first data store in the source data center 530 (e.g., a database, etc.). At step 560, the process runs the application-specific data export utility at the data migration appliance with the export utility exporting the data from the selected data store in source data center 530 to the data migration appliance. The export utility may export the data from a first data format utilized by a source application (e.g., a source DBMS used at the source data center) to a different type of application that is planned on being used at the target data center (e.g., a target DBMS used at the target data center) as supported by data export utility.

The process determines whether there are more data stores to export from the source data center to the data migration appliance (decision 570). If there are more data stores to export, then decision 570 branches to the ‘yes’ branch which loops back to step 550 to select and export the next data store. This looping continues until there are no more data stores to export, at which point decision 570 branches to the ‘no’ branch exiting the loop. At step 580, the entity performing the exporting routine at the source data center transports data migration appliance 300 to the target data center to import data. The data migration appliance, at this point, has the application data set and the utilities stored on a nonvolatile storage device included in the data migration appliance. The export processing shown in FIG. 5 processing thereafter ends at 595.

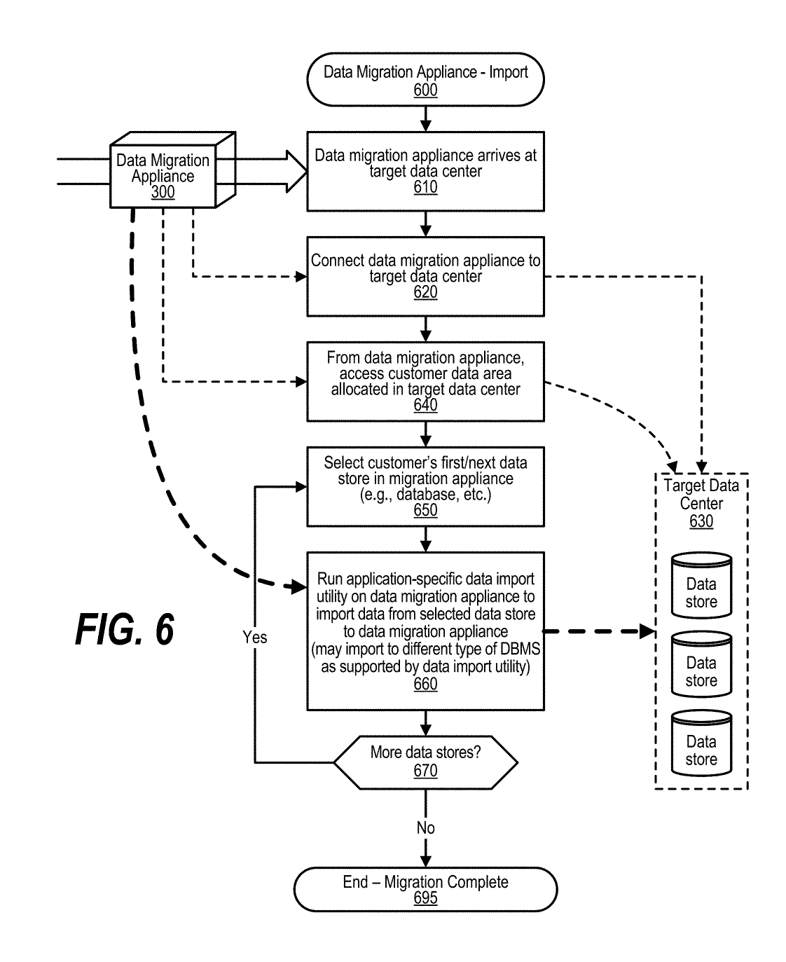

FIG. 6 is a flowchart depicting steps taken when importing application data to a target data center using a migration appliance that includes application-native export and import capabilities. FIG. 6 processing commences at 600 and shows the steps taken by a process that imports data from the data migration appliance to the target data center. At step 610, the data migration appliance arrives at target data center. At step 620, the process connects the data migration appliance to target data center using an interface at the data migration appliance to connect to a corresponding interface at the target data center.

At step 640, the process running at the data migration appliance, accesses the customer data area that has been allocated in target data center 630. At step 650, the process selects the customer's first data store that was exported to the nonvolatile storage device in the data migration appliance (e.g., a database, etc.). At step 660, the process runs the application-specific data import utility on the data migration appliance to import the application data set from the selected data store on the data migration appliance to target data center 630. Similar to the export utility described in FIG. 5, the import utility may also import the application data set to a different type of application. For example, an application data set corresponding to a first DBMS that was used on the source data center may be imported to a different (second) DBMS that is planned to be used at the target data center with the data import utility supporting the conversion from one type of application (e.g., DBMS, etc.) to another type of application.

The process next determines whether there are more data stores comprising the customer's application data set stored on the data migration appliance that need to be migrated (imported) to the target data center (decision 670). If there are more data stores to import, then decision 670 branches to the ‘yes’ branch which loops back to step 650 to select and import the next data store using the appropriate import software application utility. This looping continues until there are no more data stores to import, at which point decision 670 branches to the ‘no’ branch exiting the loop. The import processing shown in FIG. 6 processing thereafter ends at 695.

Some embodiments of the present invention may include one, or more, of the following features, characteristics, advantages and/or operations: (i) using datastore-provided utilities as plugins; (ii) provides a data migration appliance including: (a) a plurality of input modules including a first input module structured and/or programmed to receive migrating data from a database/data access software solution of a first type, and a second input module structured and/or programmed to receive migrating data from a database/data access software solution of a second type which is different than the first type, (b) a set of output module(s) including a first input module structured and/or programmed to store migrating data from a database/data access software solution of a third type, and (c) a data migration module structured and/or programmed to receive migrating data from any of the input modules of the plurality of output modules and deliver it to any output module of the set of output module(s) to effect data migration; (iii) each different type of database/data access software solution stores the data in an entirely different format, different layout and different structure with respect to physical and/or logical addresses at which the data is stored; (iv) data stored according to each different type of database/data access software solution is not readable by a database engine corresponding to a different type; (v) each different type of database/data access software solution is proprietary to a different entity; (vi) the first and second types are characterized by different communication protocols; (vii) the third type is the same as one of the first or second types; and/or (viii) the third type is different than both of the first or second types.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method comprising:
identifying a migration condition at a data migration appliance that is migrating an application data set from a source data center to a target data center, wherein the data migration appliance includes a set of processor(s), a memory, a nonvolatile storage device, and one or more external interfaces, and wherein the data migration appliance has application native capability regarding one or more database management system (DBMS) application programs;
loading, by the set of processor(s) to the nonvolatile storage device, one or more software application utilities corresponding to the application data set;
exporting, by the set of processor(s), the application data set from the source data center to the nonvolatile storage device in the data migration appliance using one of the software application utilities; and
importing, by the set of processor(s), the application data set stored on the nonvolatile storage device to the target data center using one of the software application utilities.

2. The method of claim 1 further comprising:
comparing a set of one or more previously loaded software application utilities stored on the nonvolatile storage device with the identified migration condition;
identifying at least one of the software application utilities that is not included in the previously loaded software application utilities based on the comparing; and
loading, by the set of processor(s) to the nonvolatile storage device, the identified software application utilities.

3. The method of claim 1 further comprising:
receiving a set of requirements corresponding to the migration from the source data center to the target data center, wherein the set of requirements identifies a software application; and
installing, by the set of processor(s), the identified software application onto the nonvolatile storage device in the data migration appliance;

4. The method of claim 3 further comprising:
after the exporting:
executing, by the set of processor(s), the installed software application at the data migration appliance, wherein the executing results in usage of the application data stored on the nonvolatile storage device.

5. The method of claim 1 further comprising:
transporting the data migration appliance from the source data center to the target data center after the exporting and before the importing.

6. The method of claim 1 wherein the exporting further comprises:
connecting the external interface of the data migration appliance to a source interface at the source data center;
accessing, by the data migration appliance; the application data set stored at the source data set, wherein the application data set is stored in a first format that is compatible with a first database management system (DBMS); and
executing a selected one of the software application utilities, wherein the selected software application utility is an application-specific data exporting utility, wherein the executing results in the application data set stored in source data center being formatted to a second format that is compatible with a second DBMS and stored on the nonvolatile storage device included in the data migration appliance.

7. The method of claim 1 wherein the importing further comprises:
connecting the external interface of the data migration appliance to a target interface at the target data center;
accessing, by the data migration appliance; the application data set stored on the nonvolatile storage device, wherein the application data set is stored in a first format that is compatible with a first database management system (DBMS); and
executing a selected one of the software application utilities, wherein the selected software application utility is an application-specific data importing utility, wherein the executing results in the application data set stored on the nonvolatile storage device being formatted to a second format that is compatible with a second DBMS and stored on the target data center.

8. A data migration appliance (DMA), wherein the DMA has application native capability regarding one or more database management system (DBMS) application programs comprising:
one or more processors;
an interface that connects the information handling system to another computer system;
a nonvolatile storage device accessible by at least one of the processors;
a memory coupled to at least one of the processors; and
a set of instructions stored in the memory and executed by at least one of the processors to perform actions comprising:
identifying a migration condition at a data migration appliance that is migrating an application data set from a source data center to a target data center;
loading one or more software application utilities corresponding to the application data set;
exporting the application data set from the source data center to the nonvolatile storage device in the data migration appliance using one of the software application utilities; and
importing the application data set stored on the nonvolatile storage device to the target data center using one of the software application utilities.

9. The DMA of claim 8 wherein the set of instructions stored in the memory is further executable by the processor(s) to perform the following actions:
comparing a set of one or more previously loaded software application utilities stored on the nonvolatile storage device with the identified migration condition;
identifying at least one of the software application utilities that is not included in the previously loaded software application utilities based on the comparing; and
loading, by the set of processor(s) to the nonvolatile storage device, the identified software application utilities.

10. The DMA of claim 8 wherein the set of instructions stored in the memory is further executable by the processor(s) to perform the following actions:
receiving a set of requirements corresponding to the migration from the source data center to the target data center, wherein the set of requirements identifies a software application; and
installing, by the set of processor(s), the identified software application onto the nonvolatile storage device in the data migration appliance;

11. The DMA of claim 10 wherein the set of instructions stored in the memory is further executable by the processor(s) to perform the following action:
after the exporting:
executing the installed software application at the data migration appliance, wherein the executing results in usage of the application data stored on the nonvolatile storage device.

12. The DMA of claim 8 further comprising:
transporting the DMA from the source data center to the target data center after the exporting and before the importing.

13. The DMA of claim 8 wherein the set of instructions stored in the memory is further executable by the processor(s) to perform the following actions:
connecting the external interface of the data migration appliance to a source interface at the source data center;
accessing, by the data migration appliance; the application data set stored at the source data set, wherein the application data set is stored in a first format that is compatible with a first database management system (DBMS); and
executing a selected one of the software application utilities, wherein the selected software application utility is an application-specific data exporting utility, wherein the executing results in the application data set stored in source data center being formatted to a second format that is compatible with a second DBMS and stored on the nonvolatile storage device included in the data migration appliance.

14. The DMA of claim 8 wherein the set of instructions stored in the memory is further executable by the processor(s) to perform the following actions:
connecting the external interface of the data migration appliance to a target interface at the target data center;
accessing, by the data migration appliance; the application data set stored on the nonvolatile storage device, wherein the application data set is stored in a first format that is compatible with a first database management system (DBMS); and
executing a selected one of the software application utilities, wherein the selected software application utility is an application-specific data importing utility, wherein the executing results in the application data set stored on the nonvolatile storage device being formatted to a second format that is compatible with a second DBMS and stored on the target data center.

15. A computer program product (CPP) comprising:
a storage device for storing computer code; and
a set of instructions stored in the storage device and executable by a set of processor(s) to perform actions comprising:
identifying a migration condition at a data migration appliance that is migrating an application data set from a source data center to a target data center, wherein the data migration appliance includes a set of processor(s), a memory, a nonvolatile storage device, and one or more external interfaces, and wherein the data migration appliance has application native capability regarding one or more database management system (DBMS) application programs;
loading one or more software application utilities corresponding to the application data set;
exporting the application data set from the source data center to the nonvolatile storage device in the data migration appliance using one of the software application utilities; and
importing the application data set stored on the nonvolatile storage device to the target data center using one of the software application utilities.

16. The CPP of claim 15 wherein the set of instructions stored in the memory is further executable by the processor(s) to perform the following actions:
comparing a set of one or more previously loaded software application utilities stored on the nonvolatile storage device with the identified migration condition;
identifying at least one of the software application utilities that is not included in the previously loaded software application utilities based on the comparing; and
loading the identified software application utilities.

17. The CPP of claim 15 wherein the set of instructions stored in the memory is further executable by the processor(s) to perform the following actions:
receiving a set of requirements corresponding to the migration from the source data center to the target data center, wherein the set of requirements identifies a software application; and
installing, by the set of processor(s), the identified software application onto the nonvolatile storage device in the data migration appliance;

18. The CPP of claim 17 wherein the set of instructions stored in the memory is further executable by the processor(s) to perform the following action:
after the exporting:
executing, by the set of processor(s), the installed software application at the data migration appliance, wherein the executing results in usage of the application data stored on the nonvolatile storage device.

19. The CPP of claim 15 wherein the set of instructions stored in the memory is further executable by the processor(s) to perform the following actions:
connecting the external interface of the data migration appliance to a source interface at the source data center;
accessing, by the data migration appliance; the application data set stored at the source data set, wherein the application data set is stored in a first format that is compatible with a first database management system (DBMS); and
executing a selected one of the software application utilities, wherein the selected software application utility is an application-specific data exporting utility, wherein the executing results in the application data set stored in source data center being formatted to a second format that is compatible with a second DBMS and stored on the nonvolatile storage device included in the data migration appliance.

20. The CPP of claim 15 wherein the set of instructions stored in the memory is further executable by the processor(s) to perform the following actions:
connecting the external interface of the data migration appliance to a target interface at the target data center;
accessing, by the data migration appliance; the application data set stored on the nonvolatile storage device, wherein the application data set is stored in a first format that is compatible with a first database management system (DBMS); and
executing a selected one of the software application utilities, wherein the selected software application utility is an application-specific data importing utility, wherein the executing results in the application data set stored on the nonvolatile storage device being formatted to a second format that is compatible with a second DBMS and stored on the target data center.
